(19) United States
(12) Patent Application Publication
(10) Pub. No.: US 2016/0173940 A1
(43) Pub. Date: Jun. 16, 2016

(54) IMAGE INFORMATION PROVISION DEVICE, IMAGE INFORMATION PROVISION SYSTEM, AND IMAGE INFORMATION PROVISION METHOD

(71) Applicants: Masayuki KAWAMOTO, Toyota-shi (JP); Masato ENDO, Toyota-shi (JP); Kenji MORI, Toyota-shi (JP); Ryota OSUMI, Toyota-shi (JP); Ryuta TERASHIMA, Toyota-shi (JP)

(72) Inventors: Masayuki KAWAMOTO, Toyota-shi (JP); Masato ENDO, Toyota-shi (JP); Kenji MORI, Toyota-shi (JP); Ryota OSUMI, Toyota-shi (JP); Ryuta TERASHIMA, Toyota-shi (JP)

(73) Assignee: TOYOTA JIDOSHA KABUSHIKI KAISHA, Aichi (JP)

(21) Appl. No.: 14/411,819

(22) PCT Filed: Jun. 29, 2012
(86) PCT No.: PCT/JP2012/066728

§ 371 Date: Feb. 23, 2016

(51) Int. Cl. H04N 21/442; H04N 21/858; H04N 21/462; H04N 21/81; H04N 21/4725

(52) U.S. Cl. CPC H04N 21/44222; H04N 21/812; H04N 21/4725; H04N 21/4622; H04N 21/858

(57) ABSTRACT

An image information provision device as an information terminal, for providing information relating to an image, the image information provision device including: a control section for specifying, when a predetermined object is selected on a screen in a state, in which an image of the predetermined object having an outer surface, onto which a plurality of display information pieces are added, is displayed on a display section, a display information piece that presents in a region that matches a selected position in the selection among the plurality of display information pieces added to the selected predetermined object, and outputting at least one of the specified display information piece or link information for link to the specified display information piece.

### TECHNICAL FIELD

The present invention relates to a technology of providing a user with information relating to an image.

### BACKGROUND ART

In both Patent Literatures 1 and 2 described below, a technology of providing a user with information relating to a motion image is disclosed. A motion image reproduction apparatus described in Patent Literature 1 is configured to acquire, when an object on a motion picture is selected by a user, information relating to the object from a link to provide the user with the information. According to the motion image reproduction apparatus, information to be provided to the user is changed in accordance with the type of the selected object. Moreover, in a motion image provision apparatus described in Patent Literature 2, a clickable region is set for an object on a motion image. When the clickable region is clicked, relevant information relating to the object is displayed.

### CITATION LIST

### Patent Literature

[PTL 1] JP 2011-259184 A
[PTL 2] JP 2010-81494 A

### SUMMARY OF INVENTION

When a motion image of an object associated with movement such as a vehicle is to be provided to the user, there is a fear in that display information (such as advertisements and messages from sponsors and affiliated companies, for example) added to an outer surface of the vehicle cannot be appropriately recognized by the user on a screen because a motion of the display information is large and the number of motions of the display information is large. In particular, when the number of display information pieces is large, a size of the display information piece is small, or the display information is dynamic display information such as a motion picture, the above-mentioned problem becomes more significant. Further, even in the case of not only the motion image but also a still image, it is preferred that the display information added to the object be appropriately recognized on the screen. On the other hand, the technologies described in Patent Literatures 1 and 2 described above are both a technology of recognizing the object itself such as the vehicle. Therefore, even if the above-mentioned technology is employed, it is still difficult to make the display information added to the outer surface of the object appropriately recognizable on the screen by the user.

The present invention has been made in view of the above, and has an object to realize a technology that is effective to provide a user with appropriate information relating to an image of a predetermined object having an outer surface onto which display information is added.

In order to achieve the above-mentioned object, an image information provision device according to one embodiment of the present invention is a device for providing information relating to an image and includes a control section. The image information provision device (control section) may be a device to which an image of a predefined predetermined object is distributed, for example, an information terminal (such as a cellular phone (including a smartphone) and a personal computer (PC)) or a navigation device to be mounted in a vehicle, or may be an information management center that manages images of the predetermined object.

The “image” herein includes a motion picture (also referred to as “motion image” or “video image”) and a still picture (also referred to as “still image”). The control section is configured as specifying means for specifying, when a predetermined object is selected on a screen in a state, in which an image of the predetermined object having an outer surface, onto which a plurality of display information pieces are added, is displayed on a display section, a display information piece that presents in a region that matches a selected position in the selection among the plurality of display information pieces added to the selected predetermined object. In this case, the display section may be a component of the image information provision device or may be a component of a device different from the image information provision device. The “predetermined object” herein includes, for example, a vehicle, a person, a building, a sign, an ornament, and animals and plants. The “display information” herein includes, for example, information such as advertisements, graphics, and characters added to a vehicle and information such as advertisements, graphics, and characters added to a uniform or a number cloth (number tag) for a sport player. The display information may be static display information (still picture) or dynamic display information (motion picture or video image). Moreover, for the description “display information piece that presents in a region that matches a selected position”, there is an aspect in which a region occupied by the display information piece entirely or partially matches the selected position.

Further, the control section is configured as means for providing at least one of the specified display information piece or link information linked to the specified display information piece (specifically, information in a link). In this case, the control section may output both the specified display information piece and the link information or may output any one of the specified display information piece and the link information. Moreover, the information to be output may be displayed and output to the above-mentioned display section that displays the image of the predetermined object or other display devices or may be audio-output by using a speaker or the like in place of or in addition to the display output.

In view of the above-mentioned configuration, the image information provision device may be a device including selection recognition means for recognizing whether or not the predetermined object has been selected on the screen in a state, in which the image of the predetermined object having the outer surface, onto which the plurality of display information pieces are added, is displayed on the display section, information acquisition means for acquiring information relating to the plurality of display information pieces, and output means for referring to the information acquired by the acquisition means to output the display information piece that presents in a region that matches the selected position in the selection when the selection recognition means recognizes the selection of the predetermined object.

According to the image information provision device described above, the user can be provided with appropriate information relating to the image of the predetermined object having the outer surface onto which the display information pieces are added. For example, in the case where the plurality of display information pieces are added to the outer surface of the predetermined object, each of the display information pieces can be appropriately specified so that necessary information is output to the user.

In the image information provision device according to one embodiment of the present invention, it is preferred that the control section be configured as means for acquiring information relating both to the selected predetermined object and to the plurality of display information pieces when the image of the selected predetermined object is displayed on the display section to specify the display information piece that presents in the region matching the selected position. In this case, the above-mentioned information pieces may be acquired in a simultaneous parallel manner or may be acquired at a time interval. As a result, by acquiring the information relating to the plurality of display information pieces in advance before a selecting operation for the predetermined object is performed on the screen of the display section, the acquired information can be quickly used for processing after the selecting operation for the predetermined object is performed.

In the image information provision device according to one embodiment of the present invention, it is preferred that the control section be configured as means for acquiring information relating to the selected predetermined object when the image of the selected predetermined object is displayed on the display section and acquiring information relating to the plurality of display information pieces when the selected predetermined object is subsequently selected on the screen of the display section, to thereby specify the display information piece that presents in the region matching the selected position. As a result, the information relating to the plurality of display information pieces is not required to be read in advance. Thus, a memory capacity necessary for temporarily accumulating the information in the control section can be reduced. As a result, a processing load on the control section can be reduced.

In the image information provision device according to one embodiment of the present invention, it is preferred that the control section be configured as means for specifying the display information piece that presents in the region that matches the selected position on the screen of the display section among the plurality of display information pieces added to the selected predetermined object. In this manner, the display information piece that presents at the selected position by the user can be precisely specified.

In the image information provision device according to one embodiment of the present invention, it is preferred that the control section be configured as means for outputting different information from the plurality of display information pieces when the display information present in the region that matches the selected position among the plurality of display information pieces added to the selected predetermined object cannot be specified on the screen of the display section. For example, when the display information pieces do not present in the region that matches the selected position on the screen of the display section or an insufficient selecting operation is performed, the display information piece cannot be precisely specified in some cases. In this manner, the information in accordance with the selecting operation performed by the user can be appropriately provided to the user.

An image information provision device according to one embodiment of the present invention is a device for providing information relating to an image and includes a control section. The control section is configured as means for changing, when a predetermined object is selected on a screen in a state, in which an image of the predetermined object having an outer surface, onto which a plurality of display information pieces are added, is displayed on a display section, an output mode for the plurality of display information pieces in accordance with visibility of the selected predetermined object on the screen. For example, when a size of the predetermined object on the screen is relatively large or the number of pixels of the image of the predetermined object on the screen is relatively large (or a resolution of the image of the predetermined object is relatively high), it is determined that the predetermined object has relatively high visibility. On the other hand, when the size of the predetermined object on the screen is relatively small or the number of pixels of the image of the predetermined object on the screen is relatively small (or the resolution of the image of the predetermined object is relatively low), it is determined that the predetermined object has relatively low visibility. Therefore, when the predetermined object on the screen has relatively high visibility, there is a low possibility that the user makes a wrong selection for a desired display information piece. Thus, the display information piece to be provided to the user among the plurality of display information pieces can be reduced to reduce the processing load on the processing section. On the other hand, when the predetermined object on the screen has relatively low visibility, there is a high possibility that the user makes a wrong selection for a desired display information piece. Thus, the display information piece to be provided to the user among the plurality of display information pieces is required to be increased. In this manner, appropriate information in accordance with the visibility of the predetermined object on the screen can be provided to the user.

In the image information provision device according to one embodiment of the present invention, it is preferred that, when a size of the selected predetermined object is smaller than a specified size, the control section be configured as means for extracting and outputting a larger amount of display information from the plurality of display information pieces than in a case where the size of the selected predetermined object is larger than the specified size. When the visibility on the screen is relatively low in terms of the size of the predetermined object, there is a fear in that the user may make a wrong selection for the desired display information piece. According to the image information provision device, however, information can be provided in accordance with the user's will by outputting a larger amount of the display information.

In the image information provision device according to one embodiment of the present invention, it is preferred that, when a number of pixels of the selected predetermined object on the display section is smaller than a specified number, the control section be configured as means for extracting and outputting a larger amount of display information from the plurality of display information pieces than in a case where the number of pixels is larger than the specified number. When the visibility on the screen is relatively low in terms of the number of pixels of the predetermined object, there is a fear in that the user may make a wrong selection for the desired display information piece. According to the image information provision device, however, information can be provided in accordance with the user's will by outputting a larger amount of the display information.

An image information provision device according to one embodiment of the present invention is a device for providing information relating to an image and includes a control section. The control section is configured as means for outputting, when a predetermined object is selected on a screen in a state, in which an image of the predetermined object having an outer surface, onto which dynamic display information is added, is displayed on a display section, to the display section, the image of the predetermined object in accordance with a preset schedule relating to display of the dynamic display information on the predetermined object. The “dynamic display information” herein typically includes the motion picture and the video image displayed on the display device provided to the predetermined object. The dynamic display information can also be regarded as a group of the plurality of display information pieces. In this manner, in synchronization with a display schedule of the dynamic display information displayed on the actual predetermined object, specifically, in synchronization with appropriate timing of movement of the display information on the predetermined object, the image of the predetermined object can be displayed on the display section.

In the image information provision device according to one embodiment of the present invention, it is preferred that the selected predetermined object be a vehicle capable of running on a road surface, and that the display information (a plurality of display information pieces or dynamic display information) be added to an outer surface of the vehicle. Here, when the predetermined object is a vehicle associated with movement, the display information added to the outer surface of the vehicle has a large motion and a large number of motions. Therefore, there is a fear in that the user cannot appropriately recognize the display information on the screen. Therefore, according to the image information provision device, even when the display information added to the outer surface of the vehicle has a large motion or a large number of motions, the display information can be appropriately recognized so that the user is provided with the information.

It is preferred that an image information provision system according to one embodiment of the present invention include: the image information provision device; the display section capable of displaying the image of the selected predetermined object; and an input device capable of performing a selecting operation for the selected predetermined object whose image is displayed on the display section on the screen. According to the image information provision system, the information relating to the image of the predetermined object having the outer surface, onto which the display information is added, can be appropriately recognized on the screen of the display section so as to be provided to the user.

It is preferred that the image information provision system according to one embodiment of the present invention further include: a database for receiving and storing the information relating to the image of the selected predetermined object photographed by a photographing device form the photographing device through a network. In this case, the photographing device may be included in the image information provision system as a component. In this manner, the information relating to the image of the predetermined object photographed by the photographing device can be stored in the database.

An image information provision method according to one embodiment of the present invention is a method of providing information relating to an image. The method includes: specifying, when a predetermined object is selected on a screen in a state, in which an image of the predetermined object having an outer surface, onto which a plurality of display information pieces are added, is displayed on a display section, a display information piece that presents in a region that matches a selected position in the selection among the plurality of display information pieces added to the selected predetermined object, and outputting at least one of the specified display information piece or link information for link to the display information piece. In this manner, the user can be provided with the appropriate information relating to the image of the predetermined object having the outer surface onto which the display information pieces are added. For example, in the case where the plurality of display information pieces are added to the outer surface of the predetermined object, each of the display information pieces can be appropriately specified so that the necessary information is output to the user.

### BRIEF DESCRIPTION OF DRAWINGS

FIG. 1 is a schematic diagram of an image information provision system 10 according to the present invention.

FIG. 2 is a perspective view illustrating an exterior appearance of a vehicle V1 that is an example of a predetermined object 110.

FIG. 3 is a diagram for illustrating initial image registration processing for the vehicle V1 illustrated in FIG. 2.

FIG. 4 is a table showing an example of link data.

FIG. 5 is a flowchart of image information provision processing according to the present invention.

FIG. 6 is a diagram illustrating a state in which a motion picture distributed to an information terminal 300 is displayed on a display section 320.

FIG. 7 is a diagram for illustrating a selecting operation performed when a user selects the vehicle V1 on the motion picture illustrated in FIG. 6.

FIG. 8 is a diagram illustrating a relationship between allocation regions A1 to A6 to which display information 111 to 116 added to the vehicle V1 are allocated and selected positions 331 to 333 by the user.

FIG. 9 is a diagram illustrating a state in which a web page 341 relating to Step S109 illustrated in FIG. 5 is displayed on the display section 320 of the information terminal 300.

FIG. 10 is a diagram illustrating a state in which the web page 351 relating to Step S110 illustrated in FIG. 5 is displayed on the display section 320 of the information terminal 300.

FIG. 11 is another diagram illustrating a state in which the web page 361 relating to Step S110 illustrated in FIG. 5 is displayed on the display section 320 of the information terminal 300.

FIG. 12 is a diagram illustrating a state in which the web page 371 relating to Step S111 illustrated in FIG. 5 is displayed on the display section 320 of the information terminal 300.

### DESCRIPTION OF EMBODIMENT

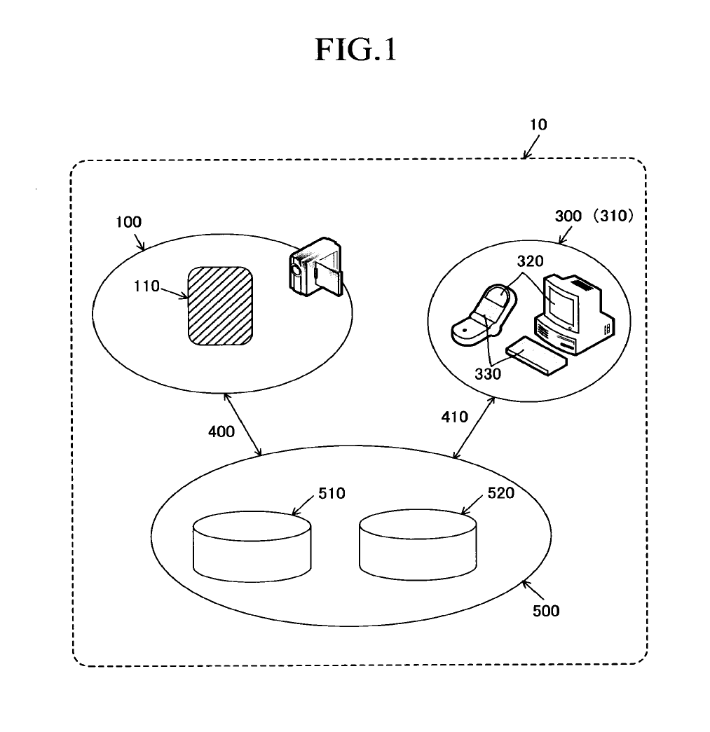

Now, an image information provision device and an image information provision system according to an embodiment of the present invention are described referring to the drawings. FIG. 1 is a schematic diagram of an image information provision system 10 according to the present invention.

The image information provision system 10 illustrated in FIG. 1 includes a photographing device 100, an information terminal 300, an information management center 500, and networks 400 and 410 as components. Although only one photographing device 100 and information terminal 300 are illustrated in FIG. 1 for convenience, a plurality of photographing devices 100 and a plurality of information terminals 300 are typically included in the image information provision system 10. Another component can also be added to the image information provision system 10 as needed. Alternatively, the image information provision system may be configured only with the information terminal 300, the information management center 500, and the network 410.

The photographing device 100 is a device for photographing a motion picture of a predefined predetermined object 110. By the photographing device 100, at least a motion picture (also referred to as “motion image” or “video image”) of the predetermined object (also referred to as “object”) 110 is obtained. The photographing device 100 may have a configuration in which a still picture (also referred to as “still image”) is obtained in addition to the motion picture of the predetermined object 110. The photographing device 100 is temporarily or continuously connected to the information management center 500 through the predetermined network (for example, a secure network such as an internet network or a dedicated line network) 400 so as to enable information communication with the information management center 500. Therefore, the image information obtained by the photographing device 100, that is, the image containing the predetermined object 100 is transmitted to the information management center 500 through the network 400. On the other hand, the photographing device 100 can be controlled by a control signal transmitted from the information management center 500 through the network 400 as needed. For example, when the photographing device 100 is configured as a live camera for photographing a fixed point or an unfixed point, an orientation and a focal length of the live camera can be adjusted by the control signal from the information management center 500. The photographing device 100 described herein corresponds to a “photographing device” of the present invention.

The predetermined object 110 includes, for example, a vehicle, a person, a building, a sign, an ornament, and animals and plants. A typical example of the vehicle includes an automobile, a bicycle, a bus, a railroad vehicle such as a train, and a racing vehicle used for races including Formula 1 (F1). A plurality of display information pieces are added to the predetermined object 110. The display information typically includes information such as an advertisement, a graphic, and a character added to the vehicle and information such as an advertisement, a graphic, and a character added to a uniform or a number cloth (number tag) for a sport player. The display information may be static display information (still picture) or may be dynamic display information (motion picture or video image).

The information terminal 300 is used to allow a user who desires distribution of the image of the predetermined object 110 to access the information management center 500. The information terminal 300 is temporarily or continuously connected to the information management center 500 through the predetermined network (for example, a secure network such as an Internet network or a dedicated line network) 410 to enable information communication with the information management center 500. In this case, the network 410 may be the same as the network 400 described above or may be different from the network 400 described above. The information terminal 300 includes a control section 310 and a display section 320.

The control section 310 (also referred to as “ECU”) is a microcomputer including a CPU, a ROM, and a RAM as main components and can appropriately execute a program stored in the control section 310 itself and a program on the network. The display section 320 is configured with a display device (display or monitor) that can display the image distributed from the information management center 500 through the network 410 in accordance with the control signal from the control section 310.

As the information terminal 300, a cellular phone (including a smartphone) or a desktop or notebook personal computer (PC) can be typically used. Further, the information terminal 300 may be configured by using an in-vehicle device to be mounted in a vehicle such as a navigation device. The information terminal 300 corresponds to an “image information provision device” of the present invention, whereas the control section 310 and the display section 320 of the information terminal 300 respectively correspond to a “control section” and a “display section” of the present invention.

Moreover, the information terminal 300 includes an input device 330. For example, in the case of a smartphone, the input device 300 is a touch panel of the display section 320. For example, in the case of a cellular phone other than a smartphone, the input device 330 is an input key provided so as to be adjacent to the display section 320. In the case of the personal computer, for example, the input device 330 is a mouse or a touchpad as a pointing device.

The information management center 500 includes a motion-picture distribution server 510 and an object information database 520. The motion-picture distribution server 510 fulfills a function of distributing the images that are periodically or continuously photographed by the photographing device 100 and are then transmitted through the network 400 to the information terminal 300 after temporarily storing or without storing the images. The image transmitted from the motion-picture distribution server 510 through the network 410 to the information terminal 300 is displayed on the display section 320 of the information terminal 300 by a motion-picture searching operation or a motion-picture reproducing operation performed on the information terminal 300 side. The object information database 520 fulfills a function of accumulating information relating to the preset predetermined object 110. The object information database 520 corresponds to a “database” of the present invention.

Image information provision processing in which the motion-picture distribution server 510 of the information management center 500 provides the information terminal 300 of the user with information relating to the image is now specifically described. As preprocessing for the image information provision processing, one or a plurality of reference images for the image of the predetermined object (also referred to as “reference images” used as a reference for the image of the predetermined object 110) are registered in advance in the object information database 520 by reference-image registration processing described later.

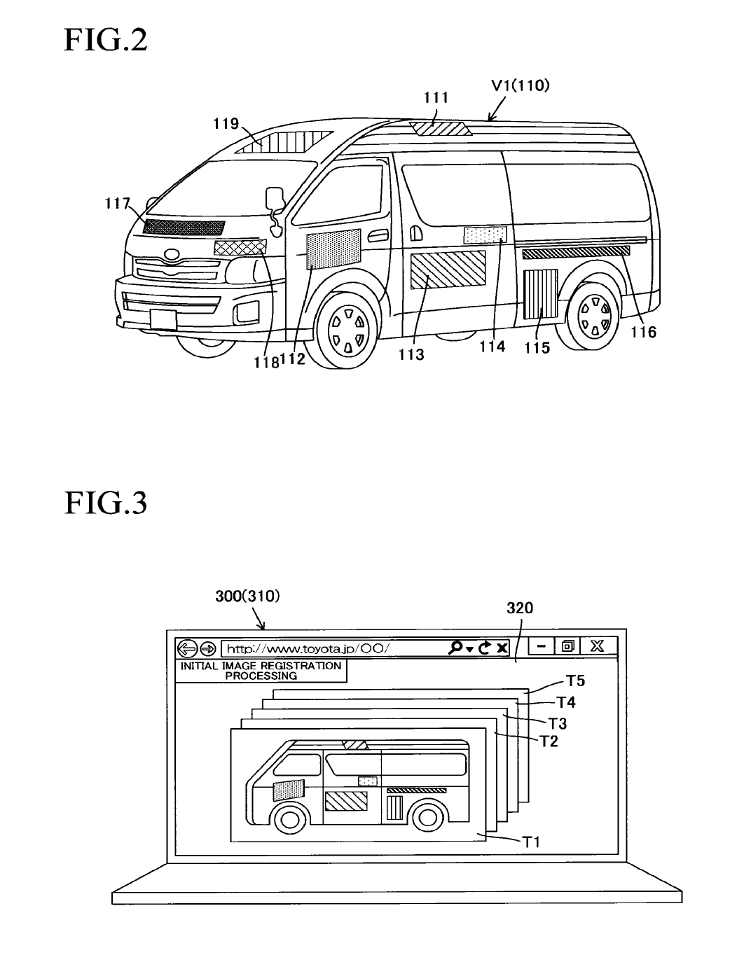

For example, a vehicle V1 illustrated in FIG. 2 is an example of the predetermined object 110. A reference image for the vehicle V1 is registered in the object information database 520 in advance. The vehicle V1 is a vehicle that can run on a road surface and is configured as a so-called “on-demand bus” that is a share-ride bus for which boarding and alighting is possible at locations and times requested in advance. At least nine display information pieces 111 to 119 are added to an outer surface of the vehicle V1 (vehicle-body surface). The display information pieces 111 to 119 can be formed by bonding a lapping material such as a film onto the outer surface of the vehicle V1, applying a coating onto the outer surface of the vehicle V1, or mounting a display device capable of displaying a still picture and a motion picture onto the outer surface of the vehicle V1. The display information pieces 111 to 119 configure a “plurality of display information pieces” of the present invention.

(Reference-Image Registration Processing)

The reference-image registration processing is processing for registering one or a plurality of reference images for each of one or a plurality of the predetermined objects 110. In the reference-image registration processing, for example, images for a plurality of set surfaces (for example, a left side surface, a right side surface, a front surface, a rear surface, and an upper surface, that is, five surfaces in total) of the vehicle V1 illustrated in FIG. 2 are prepared as five reference images for the vehicle V1. In this case, the number of set surfaces of the predetermined object 110 can be appropriately changed as needed. Further, a link template for each of the reference images is prepared. The link template contains link data in which positional information for specifying allocation regions to which a plurality of display information pieces allocated to the vehicle V1 are allocated and information in a link for linking from each of the display information pieces are associated with each other. Then, each of the reference images of the vehicle V1 is created with the link template and is then, for example, transmitted from the information terminal 300 through the network 410 to the object information database 520 so as to be registered in the object information database 520.

As the link template, link templates T1 to T5 illustrated in FIG. 3 are referred to. The link templates respectively relate to the reference images on the respective set surfaces of the vehicle V1 and each contain link data relating to the plurality of display information pieces allocated to the respective set surfaces. For example, the link template T1 contains link data relating to the plurality of display information pieces (display information pieces 111 to 116 illustrated in FIG. 2) allocated to the left side surface of the vehicle V1.

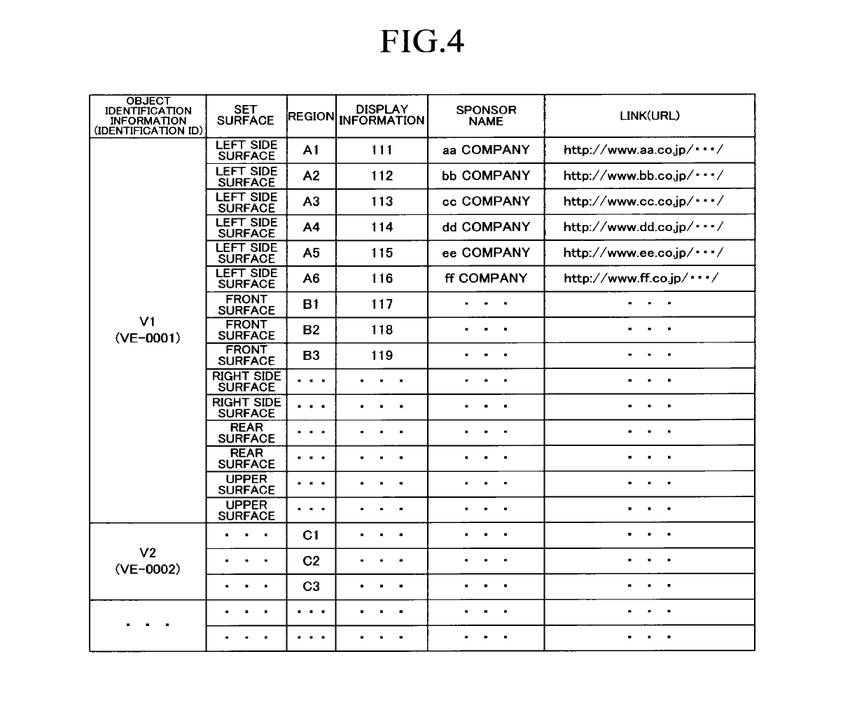

An example of the link data is shown in FIG. 4. The link data is data for each of the predetermined objects and contains the display information pieces and information relating to the set surfaces to which the display information pieces are allocated, the allocation regions for the respective display information pieces on the set surface, a sponsor name for each of the display information pieces, and a link. According to the link data, for example, for the vehicle V1 (identification ID: VE-0001), a display information piece “111” relating to an “aa company” is allocated to an allocation region “A1” on the “left side surface”. A link for the display information piece is specified as “http://www.aa.co.jp/ . . . /”. To an allocation region “A2” on the “left side surface” of the vehicle V1, a display information piece “112” relating to a “bb company” is allocated. A link for the display information piece is specified as “http://www.bb.co.jp/ . . . /”. Links for the display information pieces allocated to the other allocation regions of the vehicle V1 can also be similarly specified. Similarly, from the link data shown in FIG. 4, information pieces of the links (also referred to as “link information”) respectively corresponding to allocation regions “C1” to “C3” of a vehicle V2 (identification ID: VE-0002) and information pieces of links corresponding to allocation regions of another predefined predetermined object different from the vehicles V1 and V2 can be obtained.

(Image Information Provision Processing)

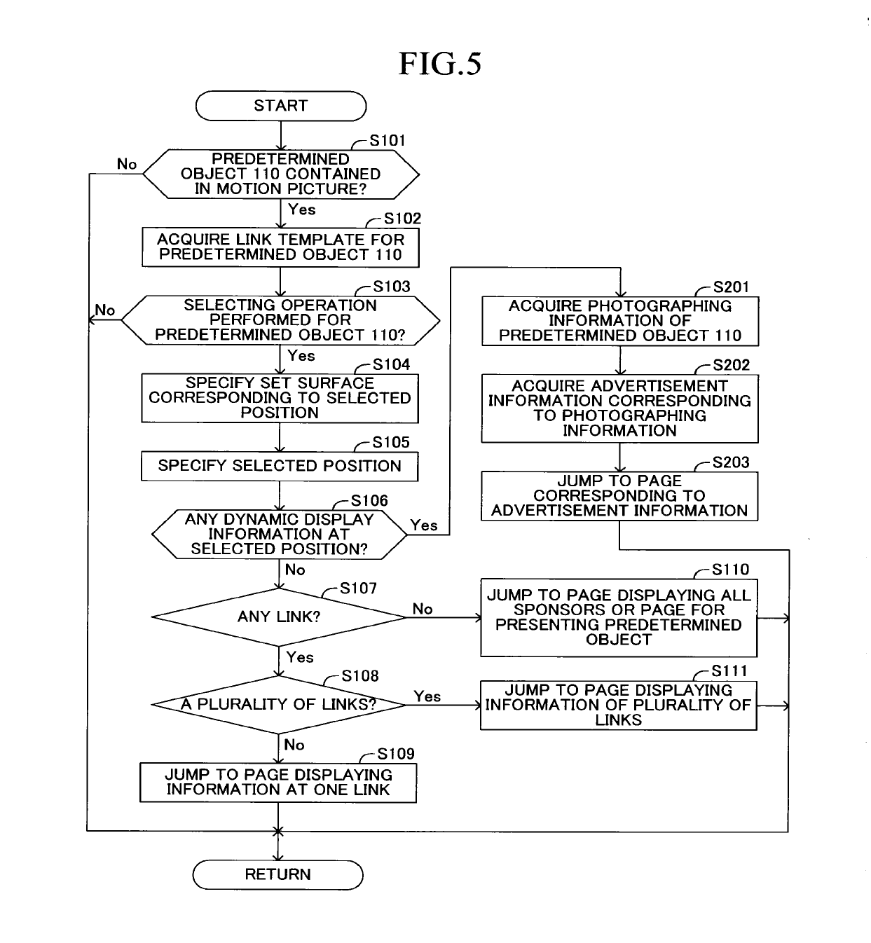

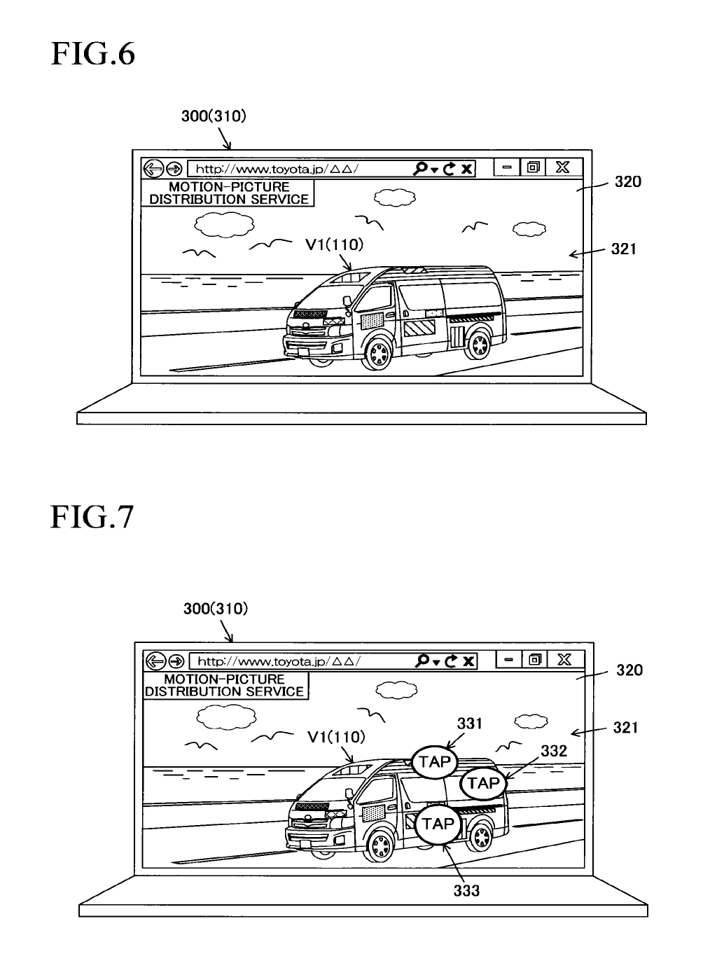

The image information provision processing illustrated in FIG. 5 is performed by the control section 310 (processing unit) of the information terminal 300 as a control main body. As preprocessing for the image information provision processing, the image is distributed from the motion-picture distribution server 510 of the information management center 500 to the information terminal 300 and the distributed image is displayed on the display section 320 of the information terminal 300 (see FIG. 6).

According to a flowchart of FIG. 5, first, in Step S101, the control section 310 determines whether or not the motion picture distributed from the motion-picture distribution server 510 of the information management center 500 through the network 410 contains the predetermined object 110, in other words, whether or not the motion picture distributed from the motion-picture distribution server 510 is a motion picture of the predetermined object 110.

The “predetermined object 110” is herein defined as an object (also referred to as “predetermined object”) for which the above-mentioned link templates are registered in advance in the object information database 520 of the information management center 500. In this case, the link templates for the predetermined object 110 are linked to the motion picture of the predetermined object 110, which is stored in the motion-picture distribution server 510, and are registered in advance in the object information database 520.

When the condition in Step S101 is satisfied (Yes in Step S101), specifically, the motion picture distributed from the motion-picture distribution server 510 is the motion picture of the predetermined object 110, the processing proceeds to Step S102. In this case, the motion picture, which is distributed to the information terminal 300 and is displayed on the display section 320, is specified as being a motion picture of the predetermined object 110. On the other hand, when the condition in Step S101 is not satisfied (No in Step S101), specifically, the motion picture distributed from the motion-picture distribution server 510 is not a motion picture of the predetermined object 110, the image information provision processing is terminated directly.

For example, when the motion picture of the vehicle V1 that is the predetermined object 110 is distributed to the information terminal 300 and is displayed on the display section 320 by a motion-picture distribution service as illustrated in FIG. 6, the control section 310 can determine that the vehicle V1 is contained in a motion picture 321 by detecting the motion picture of the vehicle V1. Specifically, when the image of the predetermined object 110 is distributed (substantially when the image of the predetermined object 110 is displayed on the display section 320), the control section 310 acquires the information relating to the predetermined object 110. As a result, for example, the motion picture displayed on the display section 320 is specified as being the motion picture of the vehicle V1.

In Step S102, the control section 310 reads out and acquires the link templates linked to the motion picture of the predetermined object 110 from the object information database 520 of the information management center 500. In the case of the vehicle V1 as the predetermined object 110, the link templates T1 to T5 described above can be used as the link templates by referring to FIG. 3, for example. In this manner, before the motion picture 321 of the vehicle V1, which is displayed on the display section 320, is selected by the user, information relating to the nine display information pieces 111 to 119 added to the vehicle V1 and information relating to the regions of the vehicle V1, to which the display information pieces are allocated, are acquired in advance. The processing in Step S102 may be performed in simultaneous parallel to the processing in Step S101 or may be performed at a time interval.

In Step S103, the control section 310 determines whether or not a selecting operation in which the predetermined object 110 displayed on the display section 320 is selected by the user on the motion picture has been operated. The selecting operation typically includes an operation of tapping (touching) and an operation of clicking the predetermined object 110 whose image is displayed on the display section 320 of the information terminal 300 on the screen. The operation is performed by using the above-mentioned input device 330 provided to the information terminal 300. Specifically, the input device 330 is a device that can perform the selecting operation for the predetermined object 110 whose image is displayed on the display section 320 on the screen, and corresponds to an “input device” of the present invention. In this case, it is preferred that a region occupied by the predetermined object 110 displayed on the display section 320 entirely or partially match a selected position selected by the selecting operation performed by the user. For example, in the case of the motion picture 321 illustrated in FIG. 6, a part of the region occupied by the vehicle V1 as the predetermined objet 110 may be subjected to the selecting operation by the user, or the region occupied by the vehicle V1 may be entirely contained in the selected position by the user.

When the condition in Step S103 is satisfied (Yes in Step S103), specifically, when the predetermined object 110 displayed on the display section 320 is subjected to the selecting operation by the user on the motion picture, the processing proceeds to Step S104. On the other hand, when the condition in Step S103 is not satisfied (No in Step S103), specifically, the predetermined object 110 displayed on the display section 320 is subjected to the selecting operation performed by the user on the motion picture, the image information provision processing is terminated directly.

A variation, in which Step S102 described above is performed when the condition in Step S103 is satisfied and then the processing proceeds to Step S104, can also be adopted. In this case, by using the selecting operation for the predetermined object 110 displayed on the display section 320 on the motion picture, which is performed by the user, as a trigger, the link templates for the predetermined object 110 are acquired. As a result, when the image of the predetermined object 110 is distributed (substantially when the image of the predetermined object 110 is displayed on the display section 320), the control section 310 acquires the information relating to the predetermined object 110. When the predetermined object 110 is subsequently selected on the screen of the display section 320, the information relating to the display information pieces 111 to 119 added to the vehicle V1 is acquired. As a result, the link templates for the predetermined objet 110 are not required to be acquired in advance before the selecting operation for the predetermined object 110 is performed. As a result, the information relating to the display information pieces 111 to 119 is not required to be read in advance. Thus, a memory capacity required to temporarily accumulate the information in the control section 310 can be reduced. Thus, a processing load on the control section 310 can be reduced. On the other hand, when Step S102 is carried out after the condition in Step S101 is satisfied as illustrated in FIG. 5, the link templates for the predetermined object 110 (that is, the information relating to the display information pieces 111 to 119) are already acquired before the determination in Step S103. Thus, when the condition in Step S103 is satisfied, the acquired information can be used so that the processing quickly proceeds to Step S104.

As another variation, when there is a predetermined object that has a high possibility of being distributed to the information terminal 300 or there is a predetermined object that is due to be distributed to the information terminal 300, the control section 310 can read out and acquire the information relating to the predetermined object (for example, the link templates described above) from the object information database 520 of the information management center 500 before Step S101, specifically, before the distribution of the image of the predetermined object. As a result, the processing after the specification of the predetermined object can be quickly carried out.

In Step S104, the control section 310 specifies which of the preset set surfaces the selected position selected by the user among the portions of the predetermined object 110 correspond to. For this purpose, it is preferred to perform matching processing between the image of the predetermined object 110 and the reference image that is registered in advance for each of the set surfaces in view of an orientation, an angle, and a size of the predetermined object 110. For example, on the motion picture 321 illustrated in FIG. 7, the user can select selected positions 331, 332, and 333 on the vehicle V1 as the predetermined object 110 by the tapping operation (selecting operation). In this case, the selected positions 331, 332, and 333 all belong to the left side surface of the above-mentioned five set surfaces of the vehicle V1. Therefore, for example, when any one of the selected positions 331, 332, and 333 is selected in Step S103, the set surface corresponding to the selected position by the user is specified as the left side surface of the vehicle V1 according to this Step S104.

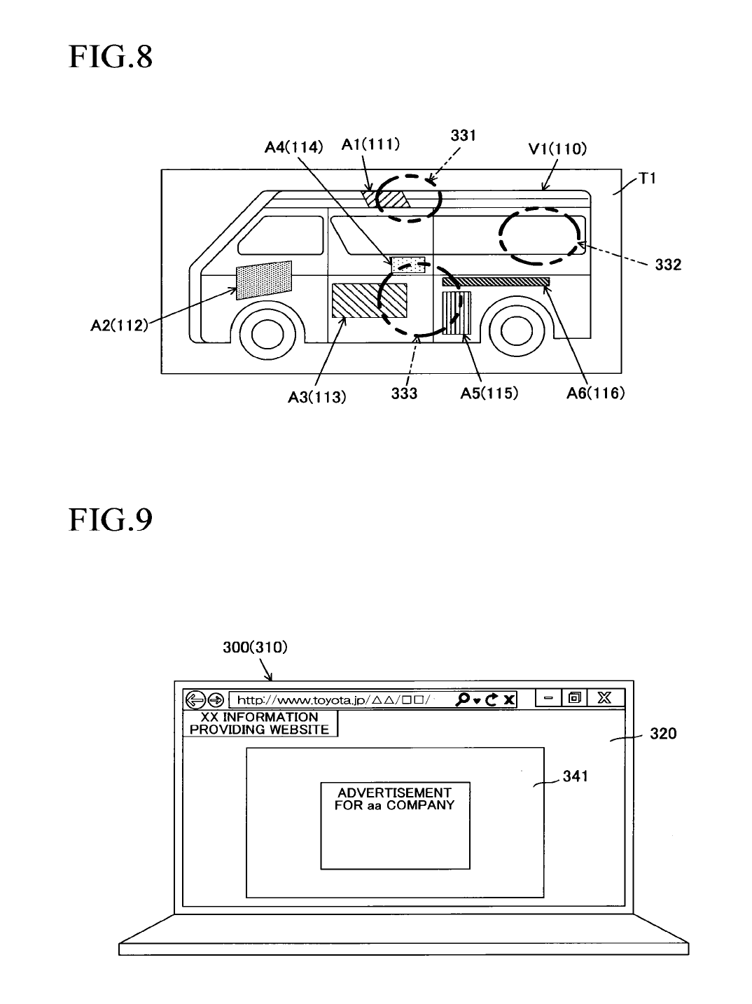

Subsequent to Step S104, in Step S105, the control section 310 specifies which position on the link template acquired in Step S102 the selected position by the user on the motion picture of the predetermined object 110 correspond to. For example, in the case of the motion picture 321 illustrated in FIG. 7, the set surface to which the selected positions 331, 332, and 333 all belong to the left side surface of the vehicle V1. Therefore, in any of the cases, the link template for the left side surface, specifically, the link template T1 illustrated in FIG. 8, is specified. Then, by using the matching processing described above, to which region on the link template T1 each of the selected positions 331, 332, and 333 corresponds is specified. In the case of the link template T1, the selected position 331 is specified as corresponding to the allocation region A1 on the left side surface of the vehicle V1. The selected position 332 is specified as corresponding to none of the allocation regions A1 to A6. The selected position 333 is specified as corresponding to all the four allocation regions A3 to A6.

In Step S106, subsequent to Step S105, the control section 310 determines whether or not dynamic display information is contained in the selected position by the user on the motion picture of the predetermined object 110. When the condition in Step S106 is satisfied (Yes in Step S106), specifically, it is determined that the dynamic display information is contained in the selected position by the user, the processing proceeds to Step S201. Otherwise (No in Step S106), specifically, it is determined that the dynamic display information is not contained in the selected position by the user, the processing proceeds to Step S107. The “dynamic display information” herein means display information itself with a motion, specifically, display information made up of a motion picture. Therefore, on the motion picture of the predetermined object 110 including a display device capable of displaying a motion image, when the motion picture on the display device is subjected to the selecting operation performed by the user with tapping or the like, it is determined that the selected position by the user contains the dynamic display information.

In Step S107, the control section 310 determines whether or not information relating to the link (typically, a uniform resource locator (URL) that is an address on the Internet or the like) is set for a region corresponding to the selected position by the user. When the condition in Step S107 is satisfied (Yes in Step S107), specifically, it is determined that there is a link, the processing proceeds to Step S108. Otherwise (No in Step S107), specifically, when it is determined that there is no link, the processing proceeds to Step S110.

For example, on the link template T1 illustrated in FIG. 8, a part of the selected position 331 matches the allocation region A1. Moreover, a part of the selected region 333 matches all of the allocation regions A3 to A6. Therefore, there exists the link (URL) linked to the allocation regions. Therefore, when the user selects the selected position 331 or the selected position 333, there exists the link corresponding to the selected position. Therefore, the control section 310 determines that the condition in Step S107 is satisfied.

When the user selects the selected position 331, the control section 310 preferably specifies the display information piece 111 that presents in the allocation region A1 that matches the selected position 331. Similarly, when the user selects the selected position 333, the control section 310 preferably specifies the display information pieces 111 to 116 that present in the allocation regions A3 to A6 that match the selected position 333. In this case, the control section 310 is configured as specification means for specifying the display information piece that presents in the region that matches the selected position among the plurality of display information pieces added to the vehicle V1 (predetermined object 110) on the screen of the display section 320. In this manner, the control section 310 can precisely specify the display information piece that presents at the selected position by the user so as to output the information relating to the display information piece.

On the other hand, on the link template T1, the selected position 332 does not match any of the allocation regions A1 to A6. Therefore, when the user selects the selected position 331, the control section 310 cannot specify the display information piece that presents in the region that matches the selected position among the plurality of display information pieces added to the vehicle V1 (predetermined object 110) on the screen of the display section 320. In this case, there is no link corresponding to the selected position. Thus, the control section 310 determines that the condition in Step S107 is not satisfied. Moreover, even when the user selects the selected position 331 or the selected position 333, the control section 310 determines that the condition in Step S107 is not satisfied in the case where the selecting operation is insufficient and therefore is not appropriately recognized.

Subsequent to Step S107, in Step S108, the control section 310 determines whether or not there are a plurality of links corresponding to the selected position by the user. When the condition in Step S108 is satisfied (Yes in Step S108), specifically, when it is determined that there are a plurality of links corresponding to the selected position by the user, the processing proceeds to Step S111. On the other hand, when the condition in Step S108 is not satisfied (No in Step S108), specifically, when it is determined that there is only one link corresponding to the selected position by the user, the processing proceeds to Step S109.

For example, on the link template T1 illustrated in FIG. 8, a part of the selected position 333 matches all of the allocation regions A3 to A6. Thus, there are a plurality of links (URLs) linked to the allocation regions. Therefore, when the user selects the selected position 333, there are a plurality of links corresponding to the selected position. Thus, the control section 310 determines that the condition in Step S108 is satisfied. On the other hand, when the user selects the selected position 331, there is only one link corresponding to the selected position. Thus, the control section 310 determines that the condition in Step S108 is not satisfied.

In Step S109, the control section 310 is linked to the link specified in Step S107 to jump to a web page on which the information in the link (link information) is displayed. As a result, for example, as FIG. 9 is referred to, a web page 341 that displays only the information in one link is displayed on the display section 320. The information in the link includes, for example, an advertisement (also referred to as “content”) and the like for an “aa company” that is an advertiser (sponsor) of the display information piece 111 allocated to the allocation region A1 of the vehicle V1 as the object 110. The advertisement for the “aa company” in this case is information relating to the display information piece 111 and is also link information linked to the display information piece 111. After performing Step S109, the control section 310 terminates the image information provision processing.

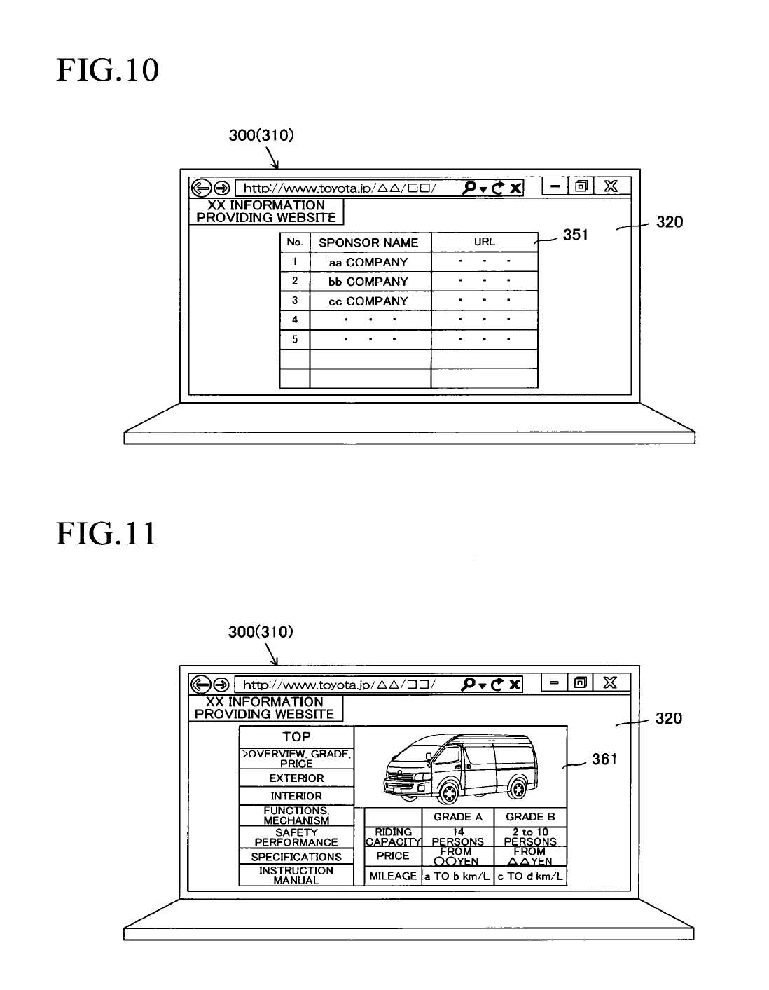

In Step S110, after it is determined in Step S107 that there is no link, the control section 310 jumps to a web page that displays information other than the information in the link. The web page includes, for example, a web page that displays a list of advertisers who provide the display information pieces added to the predetermined object 110 and a web page that displays a website where the predetermined object 110 presents. In this manner, for example, as FIG. 10 is referred to, a web page 351 that displays the advertisers of the display information pieces added to the vehicle V1 as the predetermined object 110 is displayed on the display section 320. Alternatively, as FIG. 11 is referred to, a web page 361 that presents the vehicle V1 as the predetermined object 110 is displayed on the display section 320. Specifically, both of the information pieces described on the web pages 351 and 361 are different from the plurality of display information pieces added to the vehicle V1. As a result, even when the display information pieces added to the vehicle V1 cannot be precisely specified, information in accordance with the selected operation performed by the user can be appropriately provided to the user. After executing Step S110, the control section 310 terminates the image information provision processing.

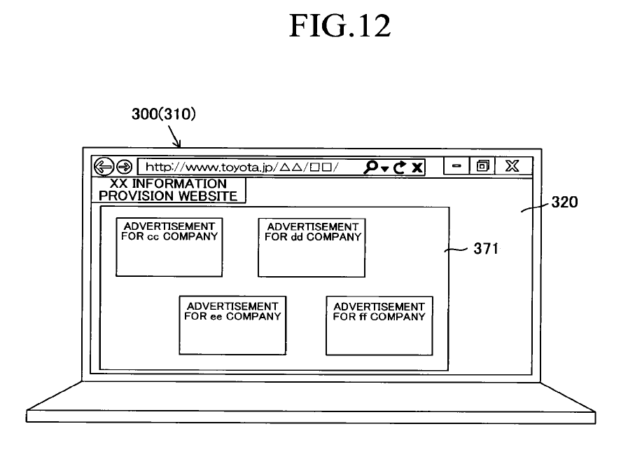

In Step S111, the control section 310 is linked to the plurality of links specified in Step S108 to jump to a web page on which the information pieces in the plurality of links are displayed. As a result, for example, as FIG. 12 is referred to, a web page 371 that displays the information pieces in four links are displayed on the display section 320. The information in the links include, for example, an advertisement for a “cc company”, an advertisement for a “dd company”, an advertisement for an “ee company”, and an advertisement for an “ff company” that are each an advertiser of the display information pieces 113, 114, 115, and 116 allocated to the respective allocation regions A3, A4, A5, and A6 of the vehicle V1 as the predetermined object 110. The advertisement for each of the “cc company” to the “ff company” in this case is information relating to each of the display information pieces 113 to 116 and is also link information linked to each of the display information pieces 113 to 116. After performing Step S111, the control section 310 terminates the image information provision processing. In Step S111 and Step S109 described above, when the link information is displayed on the display section 320, display information in a referrer of the link can also be displayed at the same time. In this manner, the contents of the display information selected by the user can be precisely recognized with the link information.

In Step S201, the control section 310 accesses the object information database 520 of the information management center 500 to acquire photographing information of the predetermined object 110, which is preregistered in the object information database 520. The photographing information includes information such as a time at which the predetermined object 110 is photographed and a location at which the predetermined object 110 is photographed.

In Step S202, the control section 310 accesses the object information database 520 of the information management center 500 to acquire advertisement information corresponding to the photographing information acquired in Step S201, which is preregistered in the object information database 520. The advertisement information includes a type of the advertisement, a name of the advertisement, and the like.

In Step S203, the control section 310 jumps to a web page corresponding to the advertisement information acquired in Step S202. In this manner, information on the web page is displayed. After executing Step S203, the image information provision processing is terminated. In association with Step S203, when the predetermined object 110 is selected on the screen, the control section 310 preferably outputs the image of the predetermined object 110 to the display section 320 in accordance with a preset schedule relating to the display of the dynamic display information on the predetermined object 110. As a result, in synchronization with the display schedule of the dynamic display information displayed on the actual predetermined object 110, specifically, in accordance with appropriate timing of the movement of the display information on the predetermined object 110, the image of the predetermined object 110 can be displayed on the display section 320.

According to the embodiment described above, the information terminal 300 is configured as the image information provision device that includes the display section 320 capable of displaying the image distributed from the information management center 500 through the network 410 and the control section 310 for specifying, when the predetermined object 110 is selected on the screen in a state, in which the image of the predetermined object 110 having the outer surface, onto which the plurality of display information pieces 111 to 119 are added, is displayed on the display section 320, the display information piece that presents in the region that matches the selected position in the selection among the plurality of display information pieces 111 to 119 added to the selected predetermined object 110 and outputting at least one of the specified display information piece or the link information linked to the display information piece.

Further, the control section 310 of the information terminal 300 is configured as the image information provision device including selection recognition means for recognizing whether or not the predetermined object 110 has been selected on the screen in a state, in which the image of the predetermined object 110 having the outer surface, onto which the plurality of display information pieces 111 to 119 are added, is displayed on the display section 320, information acquisition means for acquiring information relating to the plurality of display information pieces 111 to 119, and output means for referring to the information acquired by the acquisition means to output the display information piece that presents in a region that matches the selected position in the selection when the selection recognition means recognizes the selection of the predetermined object 110.

Therefore, by performing the image information provision processing illustrated in FIG. 5 using the information terminal 300, the plurality of display information pieces (for example, the display information pieces 111 to 119 illustrated in FIG. 2) added to the outer surface of the predetermined object 110 can be appropriately specified. In particular, even when the motion of the display information pieces added to the outer surface is large or the number of motions is large as in the case of the vehicle V1, the display information can be appropriately specified so that necessary information is provided to the user.

As a variation of the image information provision processing illustrated in FIG. 5, the steps of recognizing the dynamic display information (Steps S106 and S201 to S203) can be omitted. Further, the processing in Step S106 and in the following steps can be omitted, while the display information piece that presents at the selected position specified in Step S105 can be displayed on the display section 320. In this case, the display information piece is preferably displayed on the display section 320 in an enlarged manner. In this fashion, the contents of the display information piece selected by the user can be precisely recognized.

Further, as a variation or an additional example of the embodiment described above, when the predetermined object 110 is selected on the screen, the control section 310 is configured as means for changing an output mode of the plurality of display information pieces in accordance with visibility of the selected predetermined object 110 on the screen. For example, when the size of the predetermined object 110 is relatively large on the screen or the number of pixels of the image of the predetermined object 110 on the screen is relatively large (or a resolution of the image of the predetermined object 110 is relatively high), it is determined that the visibility of the predetermined object 110 is relatively high. On the other hand, when the size of the predetermined object 110 is relatively small on the screen or the number of pixels of the image of the predetermined object 110 on the screen is relatively small (or the resolution of the image of the predetermined object 110 is relatively low), it is determined that the visibility of the predetermined object 110 is relatively low. Therefore, when the visibility of the predetermined object 110 is relatively high on the screen, there is a low possibility that the user makes a wrong selection for a desired display information piece. Thus, the display information piece to be provided to the user among the plurality of display information pieces can be reduced to reduce the processing load on the control section 310. On the other hand, when the visibility of the predetermined object 110 is relatively low on the screen, there is a high possibility that the user makes a wrong selection for a desired display information piece. Thus, the display information piece to be provided to the user among the plurality of display information pieces is required to be increased. As a result, appropriate information in accordance with the visibility of the predetermined object on the screen can be provided to the user.

In particular, when the size of the predetermined object 110 is smaller than a specified size, the control section 310 is preferably configured as means for extracting and outputting a larger amount of the display information than that in the case where the size of the predetermined object 110 is larger than the specified size from the plurality of display information pieces. Alternatively, when the number of pixels of the predetermined object 110 on the display section 320 is smaller than a specified number, the control section 310 is preferably configured as means for extracting and outputting a larger amount of the display information than that in the case where the number of pixels is larger than the specified number from the plurality of display information pieces. As a result, a larger amount of the display information is output. Therefore, even when the visibility of the predetermined object 110 is relatively low, the user can be prevented from making a wrong selection for the desired display information piece. As a result, the information can be provided in accordance with the user's will.

Although the case where the image information provision device for providing the information relating to the image is configured by using the information terminal 300 has been described in the embodiment described above, the image information provision device may be configured by the information management center 500 for managing images in the present invention. In this case, a control section of the information management center 500 functions as a control main body to perform the image information provision processing illustrated in FIG. 5.

Although the case where the information relating to the predetermined object 110 that is subjected to the selecting operation by the user on the screen of the display section 320 is output to the display section 320 has been described in the embodiment described above, the information to be output may be displayed and output to a display device other than the display section 320 or may be audio-output by using a speaker or the like in place of or in addition to the display output in the present invention.

Although the case where the motion picture is distributed from the image management center 500 has been described in the embodiment described above, the present invention is applicable to a technology of distributing at least one of the motion picture and the still picture from the information management center 500.

Based on the description of the embodiment described above and various variations, the present invention can have the following aspects.

In the present invention, the following aspect (aspect 1) may be adopted.

“An image information provision method of providing information relating to an image, the method including:

specifying, when a predetermined object is selected on a screen in a state, in which an image of the predetermined object having an outer surface, onto which a plurality of display information pieces are added, is displayed on a display section, a display information piece that presents in a region that matches a selected position in the selection among the plurality of display information pieces added to the selected predetermined object, and outputting at least one of the specified display information piece or link information for link to the specified display information piece; and

acquiring information relating both to the predetermined object and to the plurality of display information pieces when the image of the predetermined object is displayed on the display section to specify the display information piece that presents in the region matching the selecting position.”

In the present invention, the following aspect (aspect 2) may be adopted.

“An image information provision method of providing information relating to an image, the method including:

specifying, when a predetermined object is selected on a screen in a state, in which an image of the predetermined object having an outer surface, onto which a plurality of display information pieces are added, is displayed on a display section, a display information piece that presents in a region that matches a selected position in the selection among the plurality of display information pieces added to the selected predetermined object, and outputting at least one of the specified display information piece or link information for link to the specified display information piece; and

acquiring information relating to the selected predetermined object when the image of the selected predetermined object is displayed on the display section and acquiring information relating to the plurality of display information pieces when the selected predetermined object is subsequently selected on the screen of the display section, to thereby specify the display information piece that presents in the region matching the selected position.”

In the present invention, the following aspect (aspect 3) may be adopted.

“An image information provision method as described in the aspect 1 or 2, further including specifying the display information piece that presents in the region that matches the selected position on the screen of the display section among the plurality of display information pieces added to the selected predetermined object.”

In the present invention, the following aspect (aspect 4) may be adopted.

“An image information provision method as described in any one of the aspects 1 to 3, further including outputting different information from the plurality of display information pieces when the display information that presents in the region that matches the selected position among the plurality of display information pieces added to the selected predetermined object cannot be specified on the screen of the display section.”

In the present invention, the following aspect (aspect 5) may be adopted.

“An image information provision method of providing information relating to an image, the method including changing, when a predetermined object is selected on a screen in a state, in which an image of the predetermined object having an outer surface, onto which a plurality of display information pieces are added, is displayed on a display section, an output mode for the plurality of display information pieces in accordance with visibility of the selected predetermined object on the screen.”

In the present invention, the following aspect (aspect 6) may be adopted.

“An image information provision method as described in the aspect 5, further including extracting and outputting, when a size of the selected predetermined object is smaller than a specified size, a larger amount of display information from the plurality of display information pieces than in a case where the size of the selected predetermined object is larger than the specified size, to thereby change the output mode for the plurality of display information pieces.”

In the present invention, the following aspect (aspect 7) may be adopted.

“An image information provision method as described in the aspect 5, further including extracting and outputting, when a number of pixels of the selected predetermined object on the display section is smaller than a specified number, a larger amount of display information from the plurality of display information pieces than in a case where the number of pixels is larger than the specified number, to thereby change the output mode for the plurality of display information pieces.”

In the present invention, the following aspect (aspect 8) may be adopted.

“An image information provision method of providing information relating to an image, the method including outputting, when a predetermined object is selected on a screen in a state, in which an image of the predetermined object having an outer surface, onto which dynamic display information is added, is displayed on a display section, to the display section, the image of the predetermined object in accordance with a preset schedule relating to display of the dynamic display information on the predetermined object.”

In the present invention, the following aspect (aspect 9) may be adopted.

“An image information provision method as described in any one of the aspects 1 to 8,

in which the predetermined object is a vehicle capable of running on a road surface, and

in which the display information is added to an outer surface of the vehicle.”

In the present invention, the following aspect (aspect 10) may be adopted.

“An image information provision device to be connected to an information management center for managing information relating to an image through a network, the image information provision device including:

a display section capable of displaying an image distributed from the information management center through the network; and

a control section for specifying, when a predetermined object is selected on a screen in a state, in which an image of the predetermined object having an outer surface, onto which a plurality of display information pieces are added, is displayed on the display section, a display information piece that presents in a region that matches a selected position in the selection among the plurality of display information pieces added to the selected predetermined object, and outputting at least one of the specified display information piece or link information for link to the specified display information piece.”

In the present invention, the following aspect (aspect 11) may be adopted.

“An image information provision device as described in the aspect 10, in which the control section acquires both the selected predetermined object and the plurality of display information pieces from the information management center when the image of the selected predetermined object is distributed from the information management center and specifies the display information piece that presents in the region matching the selected position.”

In the present invention, the following aspect (aspect 12) may be adopted.

“An image information provision device as described in the aspect 10, in which the control section acquires information relating to the selected predetermined object from the information management center when the image of the selected predetermined object is distributed from the information management center and acquires the plurality of display information pieces from the information management center when the selected predetermined object is selected on the screen of the display section, to thereby specify the display information piece that presents in the region matching the selected position.”

In the present invention, the following aspect (aspect 13) may be adopted.

“An image information provision device as described in any one of the aspects 10 to 12, in which the control section specifies the display information piece that presents in the region that matches the selected position on the screen of the display section among the plurality of display information pieces added to the selected predetermined object.”

In the present invention, the following aspect (aspect 14) may be adopted.

“An image information provision device as described in any one of the aspects 10 to 13, in which the control section outputs different information from the plurality of display information pieces when the display information that presents in the region that matches the selected position among the plurality of display information pieces added to the selected predetermined object cannot be specified on the screen of the display section.”

In the present invention, the following aspect (aspect 15) may be adopted.

“An image information provision device to be connected to an information management center for managing information relating to an image through a network, the image information provision device including:

a display section capable of displaying an image distributed from the information management center through the network; and

a control section for changing, when a predetermined object is selected on a screen in a state, in which an image of the predetermined object having an outer surface, onto which a plurality of display information pieces are added, is displayed on a display section, an output mode for the plurality of display information pieces in accordance with visibility of the selected predetermined object on the screen.”

In the present invention, the following aspect (aspect 16) may be adopted.

“An image information provision device as described in the aspect 15, in which, when a size of the selected predetermined object is smaller than a specified size, the control section extracts and outputs a larger amount of display information from the plurality of display information pieces than in a case where the size of the selected predetermined object is larger than the specified size, to thereby change the output mode for the plurality of display information pieces.”

In the present invention, the following aspect (aspect 17) may be adopted.

“An image information provision device as described in the aspect 15, in which, when a number of pixels of the selected predetermined object on the display section is smaller than a specified number, the control section extracts and outputs a larger amount of display information from the plurality of display information pieces than in a case where the number of pixels is larger than the specified number, to thereby change the output mode for the plurality of display information pieces.”

In the present invention, the following aspect (aspect 18) may be adopted.

“An image information provision device to be connected to an information management center for managing information relating to an image through a network, the image information provision device including:

a display section capable of displaying an image distributed from the information management center through the network; and

a control section for outputting, when a predetermined object is selected on a screen in a state, in which an image of the predetermined object having an outer surface, onto which dynamic display information is added, is displayed on a display section, to the display section, the image of the predetermined object in accordance with a preset schedule relating to display of the dynamic display information on the predetermined object.”

In the present invention, the following aspect (aspect 19) may be adopted.

“An image information provision device as described in any one of the aspects 10 to 18,

in which the selected predetermined object is a vehicle capable of running on a road surface, and

in which the display information is added to an outer surface of the vehicle.”

In the present invention, the following aspect (aspect 20) may be adopted.

“An image information provision system, including:

the image information provision device as described in any one of the aspects 1 to 19;

the information management center capable of managing the information relating to the image and distributing the image to the image information provision device; and

a network for connecting the image information provision device and the information management center.”

In the present invention, the following aspect (aspect 21) may be adopted.

“An image information provision system as described in the aspect 20, in which the information management center includes a database for receiving and storing the information relating to the image of the predetermined object photographed by a photographing device form the photographing device through a network.”

1. An image information provision device for providing information relating to an image,
the image information provision device comprising a control section for specifying, when a predetermined object is selected on a screen in a state, in which an image of the predetermined object having an outer surface, onto which a plurality of display information pieces are added, is displayed on a display section, a display information piece that presents in a region that matches a selected position in the selection among the plurality of display information pieces added to the selected predetermined object, and outputting at least one of the specified display information piece or link information for link to the specified display information piece.

2. An image information provision device according to claim 1,
wherein the control section acquires information relating both to the selected predetermined object and to the plurality of display information pieces when the image of the selected predetermined object is displayed on the display section to specify the display information piece that presents in the region matching the selected position.

3. An image information provision device according to claim 1, wherein the control section acquires information relating to the selected predetermined object when the image of the selected predetermined object is displayed on the display section and acquires information relating to the plurality of display information pieces when the selected predetermined object is subsequently selected on the screen of the display section, to thereby specify the display information piece that presents in the region matching the selected position.

4. An image information provision device according to claim 1, wherein the control section specifies the display information piece that presents in the region that matches the selected position on the screen of the display section among the plurality of display information pieces added to the selected predetermined object.

5. An image information provision device according to claim 1, wherein the control section outputs different information from the plurality of display information pieces when the display information that presents in the region that matches the selected position among the plurality of display information pieces added to the selected predetermined object cannot be specified on the screen of the display section.

6. An image information provision device for providing information relating to an image,
the image information provision device comprising a control section for changing, when a predetermined object is selected on a screen in a state, in which an image of the predetermined object having an outer surface, onto which a plurality of display information pieces are added, is displayed on a display section, an output mode for the plurality of display information pieces in accordance with visibility of the selected predetermined object on the screen.

7. An image information provision device according to claim 6, wherein, when a size of the selected predetermined object is smaller than a specified size, the control section extracts and outputs a larger amount of display information from the plurality of display information pieces than in a case where the size of the selected predetermined object is larger than the specified size, to thereby change the output mode for the plurality of display information pieces.

8. An image information provision device according to claim 6, wherein, when a number of pixels of the selected predetermined object on the display section is smaller than a specified number, the control section extracts and outputs a larger amount of display information from the plurality of display information pieces than in a case where the number of pixels is larger than the specified number, to thereby change the output mode for the plurality of display information pieces.

9. An image information provision device for providing information relating to an image,
the image information provision device comprising a control section for outputting, when a predetermined object is selected on a screen in a state, in which an image of the predetermined object having an outer surface, onto which dynamic display information is added, is displayed on a display section, to the display section, the image of the predetermined object in accordance with a preset schedule relating to display of the dynamic display information on the predetermined object.

10. An image information provision device according to claim 1,
wherein the selected predetermined object comprises a vehicle capable of running on a road surface, and
wherein the display information is added to an outer surface of the vehicle.

11. An image information provision system, comprising:
the image information provision device according to claim 1;
the display section capable of displaying the image of the selected predetermined object; and
an input device capable of performing a selecting operation for the selected predetermined object whose image is displayed on the display section on the screen.

12. An image information provision system according to claim 11, further comprising a database for receiving and storing the information relating to the image of the selected predetermined object photographed by a photographing device form the photographing device through a network.

13. An image information provision method of providing information relating to an image,
the method comprising specifying, when a predetermined object is selected on a screen in a state, in which an image of the predetermined object having an outer surface, onto which a plurality of display information pieces are added, is displayed on a display section, a display information piece that presents in a region that matches a selected position in the selection among the plurality of display information pieces added to the selected predetermined object, and outputting at least one of the specified display information piece or link information for link to the specified display information piece.
